(19) United States
(12) Patent Application Publication
(10) Pub. No.: US 2021/0157718 A1
(43) Pub. Date: May 27, 2021

(54) REDUCTION OF PAGE MIGRATION BETWEEN DIFFERENT TYPES OF MEMORY

(71) Applicant: Micron Technology, Inc., Boise, ID (US)

(72) Inventors: Dmitri Yudanov, Rancho Cordova, CA (US); Samuel E. Bradshaw, Sacramento, CA (US)

(21) Appl. No.: 16/694,345

(22) Filed: Nov. 25, 2019

(51) Int. Cl. G06F 12/02; G06F 13/16

(52) U.S. Cl. CPC G06F 12/02; G06F 2212/1024; G06F 13/1668

(57) ABSTRACT

Reduction of page migration while maintaining benefits of migration can include operations that include scoring objects and executables of application processes of a computing device based on placement and movement of the objects and executables in memory of the device, as well as grouping the objects and executables based on the placement and movement of the objects and executables in the memory. The operations can also include controlling loading and storing, in a first type of memory of the memory, at a first plurality of pages of the memory, a first group of the objects and executables at least according to the scoring. And, the operations can include controlling loading and storing, in at least one additional type of memory of the memory, at one or more additional pluralities of pages of the memory, at least one additional group of the objects and executables at least according to the scoring.

### FIELD OF THE TECHNOLOGY

At least some embodiments disclosed herein relate to reduction of page migration in memory. And, at least some embodiments disclosed herein relate to reduction of page migration between different types of memory.

### BACKGROUND

Memory, such as main memory, is computer hardware that stores information for immediate use in a computer or computing device. Memory, in general, operates at a higher speed than computer storage. Computer storage provides slower speeds for accessing information, but also can provide higher capacities and better data reliability. Random-access memory (RAM), which is a type of memory, can have high operation speeds.

Memory can be made up of addressable semiconductor memory units or cells. A memory IC and its memory units can be at least partially implemented by silicon-based metal-oxide-semiconductor field-effect transistors (MOSFETs).

There are two main types of memory, volatile and non-volatile. Non-volatile memory can include flash memory (which can also be used as storage) as well as ROM, PROM, EPROM and EEPROM (which can be used for storing firmware). Another type of non-volatile memory is non-volatile random-access memory (NVRAM). Volatile memory can include main memory technologies such as dynamic random-access memory (DRAM), and cache memory which is usually implemented using static random-access memory (SRAM).

In the context of memory, a page is a block of virtual memory. A page can be a fixed-length contiguous block of virtual memory. And, a page can be described by a single entry in a page table. A page can be the smallest unit of data in virtual memory. A transfer of pages between main memory and an auxiliary store, such as a hard disk drive, can be referred to as paging or swapping. Such a transfer can also be referred to as page migration. Also, the transfer of pages within main memory or among memory of different types can be referred to as page migration.

Virtual memory is a way to manage memory and memory addressing. Usually, an operating system, using a combination of computer hardware and software, maps virtual memory addresses used by computer programs into physical addresses in memory.

Data storage, as seen by a process or task of a program, can appear as a contiguous address space or collection of contiguous segments. For example, data storage, as seen by a process or task of a program, can appear as pages of virtual memory. An operating system (OS) can manage virtual address spaces and the assignment of real memory to virtual memory. For example, the OS can manage page migration. Also, the OS can manage memory address translation hardware in the CPU. Such hardware can include or be a memory management unit (MMU), and it can translate virtual addresses of memory to physical addresses of memory. Software of the OS can extend such translation functions as well to provide a virtual address space that can exceed the capacity of actual physical memory. In other words, software of the OS can reference more memory than is physically present in the computer.

Since virtual memory can virtually extend memory capacity, such virtualization can free up individual applications from having to manage a shared memory space. Also, since virtual memory creates a translational layer in between referenced memory and physical memory, it increases security. In other words, virtual memory increases data security by memory isolation. And, by using paging or page migration, or other techniques, virtual memory can virtually use more memory than the memory physically available. Also, using paging or page migration, or other techniques, virtual memory can provide a system for leveraging a hierarchy of memory.

Memory of a computing system can be hierarchical. Often referred to as memory hierarchy in computer architecture, memory hierarchy is composed based on certain factors such as response time, complexity, capacity, persistence and memory bandwidth. Such factors can be interrelated and can often be tradeoffs which further emphasizes the usefulness of a memory hierarchy.

Memory hierarchy can affect performance in a computer system. Prioritizing memory bandwidth and speed over other factors can require considering the restrictions of a memory hierarchy, such as response time, complexity, capacity, and persistence. To manage such prioritization, different types of memory chips can be combined to provide a balance in speed, reliability, cost, etc. Each of the various chips can be viewed as part of a memory hierarchy. And, for example, to reduce latency some chips in a memory hierarchy can respond by filling buffers concurrently and then by signaling for activating the transfer of data between chips and processor.

Memory hierarchy can be made of chips with different types of memory units or cells. For example, memory cells can be DRAM units. DRAM is a type of random access semiconductor memory that stores each bit of data in a memory cell, which usually includes a capacitor and a MOSFET. The capacitor can either be charged or discharged which represents two values of a bit, such as “0” and “1”. In DRAM, the electric charge on a capacitor leaks off, so DRAM requires an external memory refresh circuit which periodically rewrites the data in the capacitors by restoring the original charge per capacitor. DRAM is considered volatile memory since it loses its data rapidly when power is removed. This is different from flash memory and other types of non-volatile memory, such as NVRAM, in which data storage is persistent.

A type of NVRAM is 3D XPoint memory. With 3D XPoint memory, memory units store bits based on a change of resistance, in conjunction with a stackable cross-gridded data access array. 3D XPoint memory can be more cost effective than DRAM but less cost effective than flash memory. Also, 3D XPoint is non-volatile memory and random-access memory.

Flash memory is another type of non-volatile memory. An advantage of flash memory is that is can be electrically erased and reprogrammed. Flash memory is considered to have two main types, NAND-type flash memory and NOR-type flash memory, which are named after the NAND and NOR organization of memory that dictates how memory units of flash memory connected. The combination of flash memory units or cells exhibit characteristics similar to those of the corresponding gates. A NAND-type flash memory is composed of memory units organized as NAND gates. A NOR-type flash memory is composed of memory units organized as NOR gates. NAND-type flash memory may be written and read in blocks which can be smaller than the entire device. NOR-type flash permits a single byte to be written to an erased location or read independently. Because of capacity advantages of NAND-type flash memory, such memory has been often utilized for memory cards, USB flash drives, and solid-state drives. However, a primary tradeoff of using flash memory is that it is only capable of a relatively small number of write cycles in a specific block compared to other types of memory such as DRAM and NVRAM.

With the benefits of virtual memory, memory hierarchy, and page migration, there are tradeoffs. For example, page migration can increase memory bus traffic. And, page migration can be at least partially responsible for reduction in computer hardware and software performance. For example, page migration can be partially responsible for causing delays in rendering of user interface elements and sometimes can be responsible for a delayed, awkward, or flawed user experience with a computer application. Also, for example, page migration, can hinder the speed of data processing or other computer program tasks that rely on use of the memory bus. This is especially the case when data processing or tasks rely heavily on the use of the memory bus.

### BRIEF DESCRIPTION OF THE DRAWINGS

The present disclosure will be understood more fully from the detailed description given below and from the accompanying drawings of various embodiments of the disclosure.

FIGS. 1-3 illustrate flow diagrams of example operations that can provide reduction of page migration in memory while maintaining benefits of page migration, in accordance with some embodiments of the present disclosure.

FIGS. 4A and 4B illustrate an example computing device that can at least implement the example operations shown in FIGS. 1-3, in accordance with some embodiments of the present disclosure.

FIG. 5 illustrates an example networked system that includes computing devices that can provide reduction of page migration in memory while maintaining benefits of page migration for one or more devices in the networked system as well as for the networked system as a whole, in accordance with some embodiments of the present disclosure.

### DETAILED DESCRIPTION

At least some embodiments disclosed herein relate to reduction of page migration in memory. More particularly, at least some embodiments disclosed herein relate to reduction of page migration between different types of memory or between different memory modules in memory. In some embodiments, systems and methods described herein can provide reduction of page migration in memory while maintaining benefits of page migration.

In some embodiments, reduction of page migration while maintaining benefits of page migration can be implemented by a combination of operations that can include scoring objects and executables of application processes of a computing device based on placement and movement of the objects and executables in memory of the computing device. The combination of operations can also include grouping the objects and executables based on the placement and movement of the objects and executables in the memory. The combination of operations can also include controlling loading and storing, in a first type of memory of the memory or in a first memory module of the memory, at a first plurality of pages of the memory, a first group of the objects and executables at least according to the scoring. And, the operations can include controlling loading and storing, in at least one additional type of memory of the memory or in at least one additional memory module of the memory, at one or more additional pluralities of pages of the memory, at least one additional group of the objects and executables at least according to the scoring.

The combination of operations can also include controlling page migration of the first plurality of pages to the at least one additional type of memory or the at least one additional memory module, at least according to the scoring of the first group of the objects and executables. And, the combination of operations can also include controlling page migration of the one or more additional pluralities of pages to the first type of memory or the first memory module, at least according to the scoring of the at least one additional group of the objects and executables. The combination of operations can also include many other operations that can play a part in reduction of page migration while maintaining benefits of page migration. Some of the many other operations are described herein as well.

In some embodiments, a computing device, e.g., a mobile device, can have memory of different types (e.g., DRAM and NVRAM). An application process in the computing device can have executables along with loadable modules and libraries for execution. Such components that can implement an application process can be loaded in the memory. Some components can be loaded into a first type of memory or a first memory module and others can be loaded into at least one other type of memory or at least one other memory module. For example, some components can be loaded into DRAM, and others into NVRAM. Also, for example, some components can be loaded in a first memory module having DRAM and some other components can be loaded in a second memory module having DRAM that is communicatively coupled further from a controller of the device than the first memory module. Or, for example, the second memory module may not be further from the controller or have any disadvantage relative to the first memory module. Or, for example, the second memory module may be a slower memory module than the first memory module, a smaller memory module, a legacy or older module that may have been used longer or a greater amount in the device, etc.

During the execution of an application in the computing device, changes over time and other transient aspects can cause page migration (e.g., moving a page from DRAM to NVRAM and moving a page from NVRAM to DRAM, moving a page from a first memory module to a second memory module and vice versa, etc.). And, such page migration can cause traffic in the memory buses. But, the systems and methods describe herein can remedy such as problem.

Also, DRAM to NVRAM can be connected to separate memory buses, and page migration between the DRAM and NVRAM can cause traffic in the busses and performance issues. A reduction of page migration, such as among the DRAM and NVRAM, can increase the opportunities to utilize the memory buses simultaneously and hence achieve better performance.

In some embodiments, an OS can score the components and/or objects of an application for placing them in DRAM versus NVRAM. Further, the scoring can include the tracking of the migration rating of any particular object and/or component. The OS can determine placement of the objects and/or components of the application in DRAM versus NVRAM, with consideration of the page migration costs. Thus, the OS can improve the overall performance of the application and possibly the device as well.

In paging or page migration, mapping (e.g., mmapping) has its cost in page faults occurring when a block of data is loaded in page cache, but is not yet mapped into the virtual memory space of a process. In some cases, these faults can make mapping substantially slower than standard file I/O.

The scoring described herein can include detecting the aforesaid faults and can be based on, at least partially, the location, the level, the amount, or the frequency of the faults. The OS can measure the evolution of mapped objects and their size, accessed size, properties, and other aspects critical for user experience. These measurements can be compared against other objects or files during runtime, in the scoring. The OS can also measure executable loading time, and measure criticality of objects in each generation of a data structure used to manage objects (e.g., a heap, a stack, etc.) to enhance object placement in memory.

Also, as a result of the measurements and/or the scoring mentioned herein, the OS, another component of the device, or another component connected to the device can provide an instant user interface (UI) part (such as an instant screen of the application with rendered controls) when a user returns to the application at any time during use of the computing device. The instant UI can be or include a lightweight UI, and at least part of the instant UI can be stored in a more proximate and/or a faster part or type of memory. For example, at least part of the instant UI can be stored in DRAM (such as DRAM that is more proximate to the controller of the computing device than other parts of the memory).

In such embodiments, a user of the device can be provided pre-selected content or aspects of the UI as if a full application is available. And, during the time when the user starts interacting with the instant UI, the application can migrate and/or load other features—such as main features in a background process. This can improve performance or seam lessness of the application. And, delays due to migration can appear nonexistent.

At least some embodiments described herein are directed to improving the efficiency of migration of application data and objects between memory sections of a computing device (e.g., each memory section can include a different memory type). For example, some data and objects of an application can initially be placed in DRAM and then be moved to NVRAM or another type of memory and vice versa as the application is active in a computing device. But, this can be done in a more efficient or effective manner via a scoring system to reduce superfluous or less beneficial page migration.

The different types of memory or different memory sections can be connected to separate buses, and these buses are used by the migration of app data and objects. And, more efficient use or reduction of use of the buses by migration can improve overall memory performance. The more efficient use or reduction of use of the buses by migration can occur via a scoring process of data and objects placed and migrated in memory.

Some embodiments can score the data and objects of an application (such as via an OS) for more efficient placement and migration in memory. For example, most used data and objects can be scored high and placed in DRAM for a certain period of time. Thus, less migration to DRAM of such data and objects is needed. Rarely used data and objects can be scored lower and placed in NVRAM (or flash memory, etc.) for a certain period of time. Thus, less migration to such lower performing memory of such data and objects is needed. Therefore, migration is reduced and made more efficient, and overall performance of the memory of the device is improved for the application.

Scoring can be based at least in part on consideration of the migration costs. For example, memory mapping can provide the migration costs of page faults. The faults can occur when a block of data is loaded in page cache but is not yet mapped into the virtual memory space of the process. The OS, for example, can measure memory mapped objects, their size, accessed size, and other properties—such as properties critical for user experience and the occurrence or reduction of page faults. These measured aspects of objects of the app can be compared against similar aspects of other objects of the app or other apps used by the computing device. Also, executable loading time as well as criticality of objects in each generation of a heap (such as a JAVA heap) can be measured and be another consideration in the scoring.

In some embodiments, as mentioned herein, a lightweight UI can be stored in a faster memory type or section (e.g., DRAM), such as by default. The lightweight UI can be interacted with initially, when a user engages the app. And, in the background, while the user is initially engaging the app, other objects of the app can be migrated to the faster memory type or section according to the scoring. Thus, the user experience is enhanced. The reduction in migration based on the scoring after initial engagement of an app can make the overall experience better for the user, and the switch from the lightweight UI to a whole-featured UI can be unnoticeable to the user.

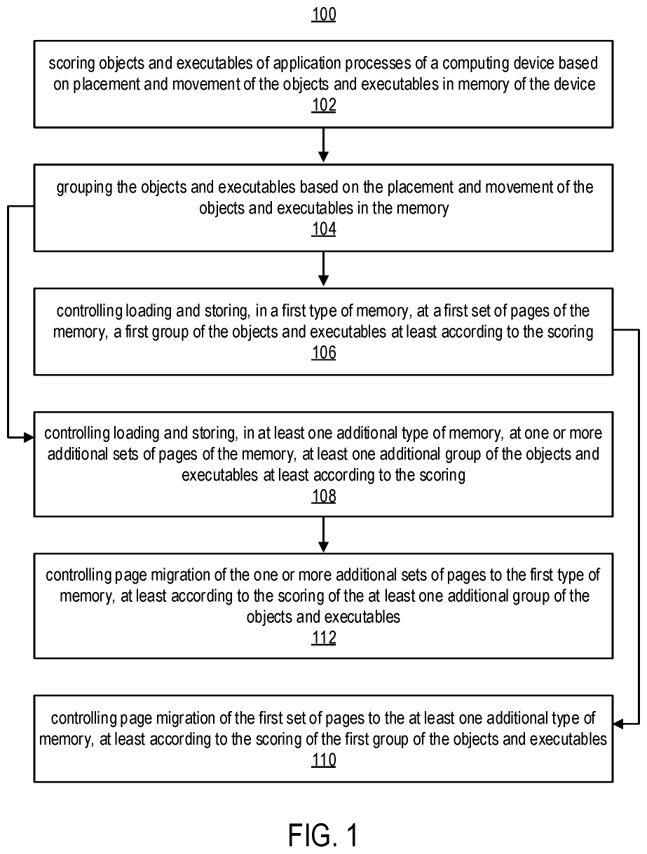

FIGS. 1-3 illustrate flow diagrams of example operations that can provide reduction of page migration in memory while maintaining benefits of page migration, in accordance with some embodiments of the present disclosure.

FIG. 1 specifically illustrates a flow diagram of example operations of method 100 that can be performed by one or more aspects of one of the computing devices described herein, such as by an OS of one of the computing devices described herein, in accordance with some embodiments of the present disclosure.

In FIG. 1, the method 100 begins at step 102 with scoring objects and executables of a plurality of application processes of a computing device based on placement and movement of the objects and executables in a memory of the computing device. The scoring can include scoring each object or executable of the plurality of application processes based at least partially on quantity, recency, or frequency of page faults associated with the object or the executable. Also, the scoring can include scoring each object or executable of the plurality of application processes based at least partially on quantity, recency, or frequency of a processor of the computing device accessing, in the memory, at least part the object or the executable. The scoring can also include scoring each object or executable of the plurality of application processes based at least partially on a size of the object or the executable or based at least partially on a size of parts of the object or the executable accessed by a processor.

Further, the scoring can include scoring each object or executable of the plurality of application processes based at least partially on a criticality rating for the object or executable.

Also, the scoring can include scoring each object or executable of the plurality of application processes based at least partially on memory bus traffic. Each type of memory or each memory module of the computing device can have its own separate memory bus.

Also, in some embodiments, the scoring can include scoring based on estimating cost of memory bus utilization to move or not to move the first and the second pluralities of pages.

At step 104, the method 100 continues with grouping the objects and executables based on the placement and movement of the objects and executables in the memory. Grouping of objects or pages can provide high efficiency since objects or pages grouped by similar criteria and scoring can be migrated, loaded, and/or stored, and denied in migration, loading, and/or storing together as groups.

At step 106, the method 100 continues with controlling loading and storing, in a first type of memory of the memory of the computing device, at a first plurality of pages of the memory, a first group of the objects and executables at least according to the scoring.

At step 108, the method 100 continues with controlling loading and storing, in at least one additional type of memory of the memory, at one or more additional pluralities of pages of the memory, at least one additional group of the objects and executables at least according to the scoring.

At step 110, the method 100 continues with controlling page migration of the first plurality of pages to the at least one additional type of memory, at least according to the scoring of the first group of the objects and executables. And, at step 112, the method 100 continues with controlling page migration of the one or more additional pluralities of pages to the first type of memory, at least according to the scoring of the at least one additional group of the objects and executables.

In some embodiments, the first type of memory can include DRAM cells. And, in such embodiments, the at least one additional type of memory can include at least one of a plurality of NVRAM cells, a plurality of 3D XPoint memory cells, or a combination thereof.

Alternatively, in some embodiments, at step 106, the method 100 continues with controlling loading and storing, in a first module of memory of the memory, at a first plurality of pages of the memory, a first group of the objects and executables at least according to the scoring. In such embodiments, at step 108, the method 100 continues with controlling loading and storing, in at least one additional module of memory of the memory, at one or more additional pluralities of pages of the memory, at least one additional group of the objects and executables at least according to the scoring. Also, in such embodiments, at step 110, the method 100 continues with controlling page migration of the first plurality of pages to the at least one additional module of memory, at least according to the scoring of the first group of the objects and executables. And, in such embodiments, at step 112, the method 100 continues with controlling page migration of the one or more additional pluralities of pages to the first module of memory, at least according to the scoring of the at least one additional group of the objects and executables.

For the purposes of this disclosure, it is to be understood that a single module of memory, in a computing device described herein, can include one or more types of memory depending on the embodiment. And, separate modules of memory described herein, as a whole, can include one or more types of memory dependent on the embodiment.

In some embodiments, the first module of memory can include DRAM cells. Also, in such embodiments, the at least one additional module of memory or the second module of memory can include at least one of a plurality of NVRAM cells, a plurality of 3D XPoint memory cells, or a combination thereof.

Also, in some embodiments, the first and the at least one additional type or module of memory are communicatively coupled to a processor or controller of the computing device. And, the first type of memory or the first module of memory can be communicatively coupled closer to the processor than the at least one additional type of memory or the at least one additional module of memory and is faster than the at least one additional type of memory or the at least one additional module of memory.

In some embodiments, at least one of the plurality of applications can include a lightweight user interface having objects and executables that are relatively smaller in size than other objects and executables in the computing device. And, the objects and executables of the lightweight user interface can be located in the first type of memory or the first module of memory. In such embodiments, the objects and executables of the lightweight user interface at least in part can have corresponding objects and executables of a non-lightweight user interface. And, the corresponding objects and executables of the non-lightweight user interface can be located in the at least one additional type of memory or in the at least one additional module of memory. Further, in such embodiments, the computing device can switch between the lightweight user interface and the non-lightweight user interface at any time at least in part based on use of the computing device by a user or scoring of objects and executables.

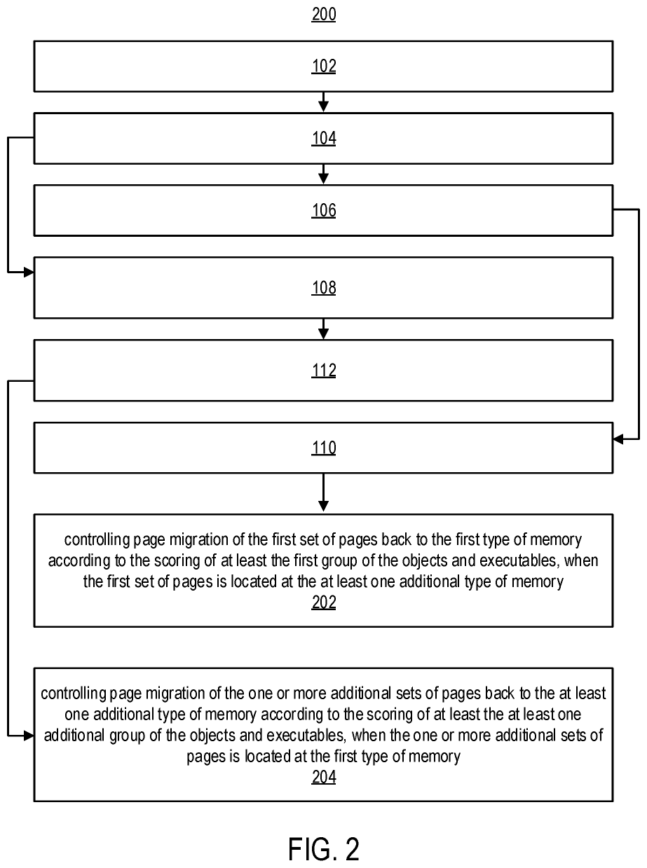

FIG. 2 specifically illustrates a flow diagram of example operations of method 200 that can be performed by one or more aspects of one of the computing devices described herein, such as by an OS of one of the computing devices described herein, in accordance with some embodiments of the present disclosure. As shown, method 200 includes steps 102 to 112 of method 100, and additionally includes steps 202 and 204.

The method 200 begins with method 100 and then at step 202, the method 200 continues with controlling page migration of the first plurality of pages back to the first type of memory according to the scoring of at least the first group of the objects and executables, when the first plurality of pages is located at the at least one additional type of memory. Alternatively, in some the embodiments, at step 202, the method 200 continues with controlling page migration of the first plurality of pages back to the first module of memory according to the scoring of at least the first group of the objects and executables, when the first plurality of pages is located at the at least one additional module of memory.

At step 204, the method 200 continues with controlling page migration of the one or more additional pluralities of pages back to the at least one additional type of memory according to the scoring of at least the at least one additional group of the objects and executables, when the one or more additional pluralities of pages is located at the first type of memory. Alternatively, in some the embodiments, at step 204, the method 200 continues with controlling page migration of the one or more additional pluralities of pages back to the at least one additional module of memory according to the scoring of at least the at least one additional group of the objects and executables, when the one or more additional pluralities of pages is located at the first module of memory.

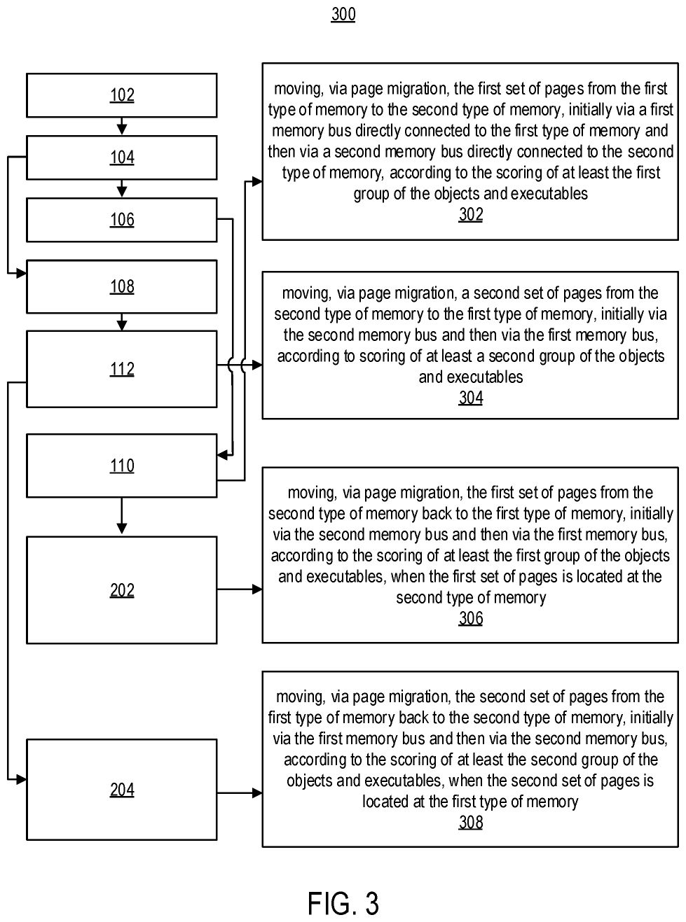

In some embodiments, the memory includes a second type of memory or a second module in the memory. FIG. 3 shows example operations when the memory includes a second type of memory or a second module in the memory.

FIG. 3 specifically illustrates a flow diagram of example operations of method 300 that can be performed by one or more aspects of one of the computing devices described herein, such as by an OS of one of the computing devices described herein, in accordance with some embodiments of the present disclosure. As shown, method 300 includes steps 102 to 112 of method 100 as well as steps 202 and 204 of method 200, and additionally includes steps 302 to 308.

The method 300 begins with steps 102 to 108 of method 100 and then at step 302, which follows step 110 of method 100, the method 300 continues with moving, via page migration, the first plurality of pages from the first type of memory to the second type of memory, initially via a first memory bus directly connected to the first type of memory and then via a second memory bus directly connected to the second type of memory, according to the scoring of at least the first group of the objects and executables. At step 304, which follows step 112 of method 100, the method 300 continues with moving, via page migration, a second plurality of pages from the second type of memory to the first type of memory, initially via the second memory bus and then via the first memory bus, according to scoring of at least a second group of the objects and executables.

Also, as shown, the method 300 continues with steps 202 and 204 of method 200 and then at step 306, which follows step 202 of method 200, the method 300 continues with moving, via page migration, the first plurality of pages from the second type of memory back to the first type of memory, initially via the second memory bus and then via the first memory bus, according to the scoring of at least the first group of the objects and executables, when the first plurality of pages is located at the second type of memory. At step 308, which follows step 204 of method 200, the method 300 continues with moving, via page migration, the second plurality of pages from the first type of memory back to the second type of memory, initially via the first memory bus and then via the second memory bus, according to the scoring of at least the second group of the objects and executables, when the second plurality of pages is located at the first type of memory.

In some embodiments, the first type of memory can include DRAM cells. Also, in such embodiments, the at least one additional type of memory or the second type of memory can include at least one of a plurality of NVRAM cells, a plurality of 3D XPoint memory cells, or a combination thereof.

Alternatively, in some the embodiments, at step 302, which follows step 110 of method 100, the method 300 continues with moving, via page migration, the first plurality of pages from the first module of memory to the second module of memory, initially via a first memory bus directly connected to the first module of memory and then via a second memory bus directly connected to the second module of memory, according to the scoring of at least the first group of the objects and executables. At step 304, which follows step 112 of method 100, the method 300 continues with moving, via page migration, a second plurality of pages from the second module of memory to the first module of memory, initially via the second memory bus and then via the first memory bus, according to scoring of at least a second group of the objects and executables.

Also, in such embodiments, at step 306, which follows step 202 of method 200, the method 300 continues with moving, via page migration, the first plurality of pages from the second module of memory back to the first module of memory, initially via the second memory bus and then via the first memory bus, according to the scoring of at least the first group of the objects and executables, when the first plurality of pages is located at the second module of memory. At step 308, which follows step 204 of method 200, the method 300 continues with moving, via page migration, the second plurality of pages from the first module of memory back to the second module of memory, initially via the first memory bus and then via the second memory bus, according to the scoring of at least the second group of the objects and executables, when the second plurality of pages is located at the first module of memory.

In some embodiments, the first module of memory can include DRAM cells. Also, in such embodiments, the at least one additional module of memory or the second module of memory can include at least one of a plurality of NVRAM cells, a plurality of 3D XPoint memory cells, or a combination thereof.

In some embodiments, such as the example illustrated by FIG. 3, the scoring can include scoring based on estimating cost of memory bus utilization to move or not to move the first and the second pluralities of pages.

In some embodiments, it is to be understood that steps of methods 100, 200, and/or 300 can be implemented as a continuous process such as each step can run independently by monitoring input data, performing operations and outputting data to the subsequent step. Also, the steps can be implemented as discrete-event processes such as each step can be triggered on the events it is supposed to triggered on and produce a certain output. It is to be also understood that each of FIGS. 1, 2, and 3 represent a minimal method within a possible larger method of a computer system more complex than the ones presented partly in FIGS. 1-3.

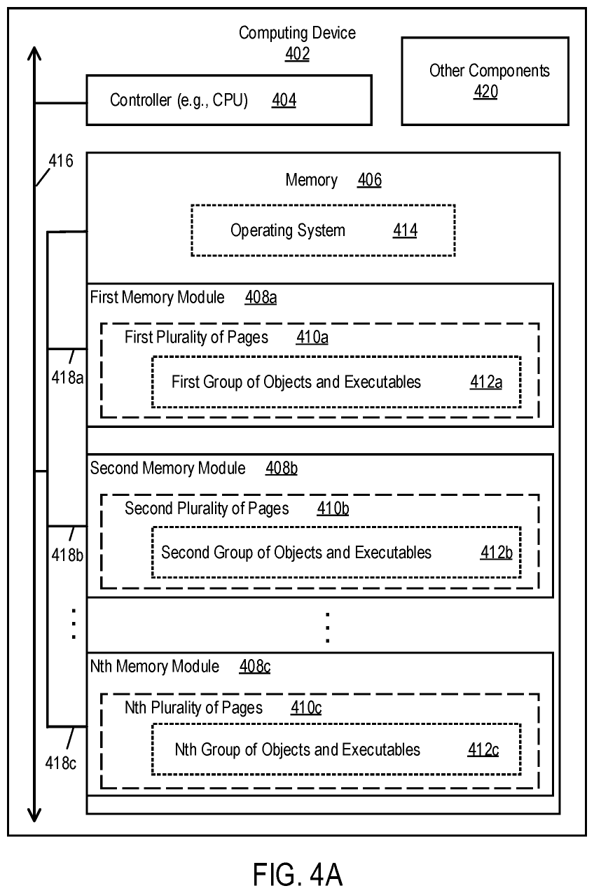

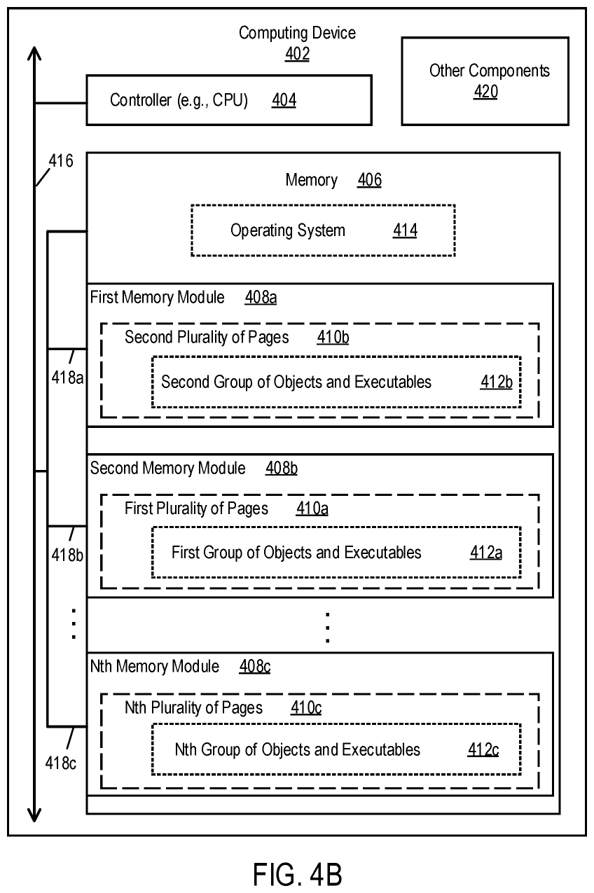

FIGS. 4A and 4B illustrate an example computing device 402 that can at least implement the example operations shown in FIGS. 1-3, in accordance with some embodiments of the present disclosure.

As shown, the computing device 402 includes a controller 404 (e.g., a CPU), a memory 406, and memory modules within the memory (e.g., see memory modules 408a, 408b, and 408c). Each memory module is shown having a respective plurality of pages (e.g., see plurality of pages 410a, 410b, and 410c). Each respective plurality of pages is shown having a respective group of objects and executables (e.g., see groups of objects and executables 412a, 412b, and 412c). The memory 406 is shown also having stored instructions of an operating system 414 (OS 414). The OS 414 as well as the objects and executables shown in FIGS. 4A and 4B include instructions stored in memory 406. The instructions are executable by the controller 404 to perform various operations and tasks within the computing device 402.

Also, as shown, the computing device 402 includes a main memory bus 416 as well as respective memory buses for each memory module of the computing device (e.g., see memory bus 418a which is for first memory module 408a, memory bus 418b which is for second memory module 408b, and memory bus 418c which is for Nth memory module 408c). The main memory bus 416 can include the respective memory buses for each memory module.

Also, as shown, the computing device 402 depicted in FIG. 4A is in a different state from the computing device depicted in FIG. 4B. In FIG. 4A, the computing device 402 is in a first state having the first plurality of pages 410a in the first memory module 408a, and the second plurality of pages 410b in the second memory module 408b. In FIG. 4B, the computing device 402 is in a second state having the first plurality of pages 410a in the second memory module 408b, and the second plurality of pages 410b in the first memory module 408a.

Also, as shown, the computing device 402 includes other components 420 that are connected to at least the controller 404 via a bus (the bus is not depicted). The other components 420 can include one or more user interfaces (e.g., GUIs, auditory user interfaces, tactile user interfaces, etc.), displays, different types of sensors, tactile, audio and/or visual input/output devices, additional application-specific memory, one or more additional controllers (e.g., GPU), one or more additional storage systems, or any combination thereof. The other components 420 can also include a network interface. And, the one or more user interfaces of the other components 420 can include any type of user interface (UI), including a tactile UI (touch), a visual UI (sight), an auditory UI (sound), an olfactory UI (smell), an equilibria UI (balance), and/or a gustatory UI (taste).

In some embodiments, the OS 414 can be configured to score objects and executables (e.g. see groups of objects and executables 412a, 412b, and 412c) of a plurality of application processes of the computing device 402 based on placement and movement of the objects and executables in the memory 406 of the computing device.

The scoring, by the OS 414, can include scoring each object or executable of the plurality of application processes (e.g. see groups of objects and executables 412a, 412b, and 412c) based at least partially on quantity, recency, or frequency of page faults associated with the object or the executable. The scoring, by the OS 414, can include scoring each object or executable of the plurality of application processes based at least partially on quantity, recency, or frequency of a processor of the computing device accessing, in the memory, at least part the object or the executable. The scoring, by the OS 414, can include scoring each object or executable of the plurality of application processes based at least partially on a size of the object or the executable or based at least partially on a size of parts of the object or the executable accessed by a processor. The scoring, by the OS 414, can include scoring each object or executable of the plurality of application processes based at least partially on memory bus traffic. The scoring, by the OS 414, can include scoring each object or executable of the plurality of application processes based at least partially on a criticality rating for the object or executable. Also, the scoring, by the OS 414, can include scoring based on estimating cost of memory bus utilization to move or not to move the first and the second pluralities of pages.

The OS 414 can also be configured to group the objects and executables (e.g. see groups of objects and executables 412a, 412b, and 412c) based on the placement and movement of the objects and executables in the memory 406. Scoring and grouping described herein can be done at page granularity or on a page level, such that some parts of objects and executables can be in one group and other parts of the same objects and executables can be in another group. If such objects and executables are separable (e.g. using memory paging) then the separated parts of the same objects and executables can be used as different or separate objects and executables. Such parts of objects or executables upon separation can remain the original link amongst them to compose the original objects and executables. Information on such links can be retained by a scoring agent of the scoring described herein. The scoring agent and/or the links can be a part of and/or used by an OS.

The OS 414 can also be configured to control loading and storing, in the first memory module 408a of the memory 406 (which can include a first type of memory), at the first plurality of pages 410a of the memory, the first group of objects and executables 412a at least according to the scoring by the OS 414. The OS 414 can also be configured to control loading and storing, in at least one additional memory module of the memory 406 (which can include a second type of memory), at one or more additional pluralities of pages of the memory (e.g., see the second plurality of pages 410b), at least one additional group of the objects and executables (e.g., see the second group of objects and executables 412b) at least according to the scoring by the OS 414. The at least one additional memory module can include the second memory module 408b.

The OS 414 can also be configured to control page migration of the first plurality of pages 410a to the at least one additional memory module (e.g., see the second memory module 408b), at least according to the scoring of the first group of objects and executables 412a. The OS 414 can also be configured to control page migration of the one or more additional pluralities of pages (e.g., see the second plurality of pages) to the first memory module 408a, at least according to the scoring of the at least one additional group of the objects and executables (e.g., see the second group of objects and executables 412b).

The OS 414 can also be configured to control page migration of the first plurality of pages 410a back to the first memory module 408a according to the scoring of at least the first group of the objects and executables 412a, when the first plurality of pages 410a is located at the at least one additional memory module (e.g., see second memory module 408b). The OS 414 can also be configured to control page migration of the one or more additional pluralities of pages (e.g., see second plurality of pages 410b) back to the at least one additional memory module (e.g., see second memory module 408b) according to the scoring of at least the at least one additional group of the objects and executables (e.g., see the second group of objects and executables 412b), when the one or more additional pluralities of pages (e.g., see second plurality of pages 410b) is located in the first memory module 408a.

In embodiments where the memory 406 includes a second type of memory, the OS 414 can be configured to move, via page migration, the first plurality of pages 410a from a first type of memory to the second type of memory, initially via a first memory bus directly connected to the first type of memory and then via a second memory bus directly connected to the second type of memory, according to the scoring of at least the first group of objects and executables 412a. For example, the first type of memory can be included in the first memory module 408a and the first memory bus can be bus 418a. And, for example, the second type of memory can be included in the second memory module 408b and the second memory bus can be bus 418b.

Also, in such embodiments, the OS 414 can be configured to move, via page migration, the second plurality of pages 410b from the second type of memory to the first type of memory, initially via the second memory bus and then via the first memory bus, according to scoring of at least the second group of objects and executables 412b. Further, the OS 414 can be configured to move, via page migration, the first plurality of pages 410a from the second type of memory back to the first type of memory, initially via the second memory bus and then via the first memory bus, according to the scoring of at least the first group of objects and executables 412a, when the first plurality of pages is located at the second type of memory. And, the OS 414 can be configured to move, via page migration, the second plurality of pages from the first type of memory back to the second type of memory, initially via the first memory bus and then via the second memory bus, according to the scoring of at least the second group of objects and executables 412b, when the second plurality of pages is located at the first type of memory.

In such embodiments, the first type of memory can include DRAM cells, and the second type of memory can include at least one of a plurality of NVRAM cells, a plurality of 3D XPoint memory cells, or a combination thereof.

In some embodiments, the first and the at least one additional type of memory (which can be included in the memory modules of the memory 406) are communicatively coupled to the controller 404 of the computing device 402. And, the first type of memory can be communicatively coupled closer to the controller 404 than the at least one additional type of memory and/or is faster than the at least one additional type of memory. For example, the first type of memory can be included in the first memory module 408a and the second type of memory can be included in the second memory module 408b, and the first memory module 408a can be communicatively coupled closer to the controller 404 than the at least one additional type of memory and/or is faster than the at least one additional type of memory.

In some embodiments, at least one of the plurality of applications includes a lightweight user interface (which can be a part of the other components 420) having objects and executables that are relatively smaller in size than other objects and executables in the computing device 402. And, the objects and executables of the lightweight user interface can be located in the first type of memory. Also, the objects and executables of the lightweight user interface can at least in part have corresponding objects and executables of a non-lightweight user interface, wherein the corresponding objects and executables of the non-lightweight user interface are located in the at least one additional type of memory (such as the second type of memory). In such embodiments, the computing device 402 can switch between the lightweight user interface and the non-lightweight user interface at any time at least in part based on use of the computing device by a user or scoring of objects and executables.

Some embodiments can include an apparatus having a processor (e.g., see controller 404) and a memory (e.g., see memory 406). The memory can include a first type of memory and a second type of memory. The first type of memory and the second type of memory can be separated in two different memory modules (e.g., see memory modules 408a and 408b). Or, each of the different memory modules can include both the first and the second type of memory.

The apparatus can also include a plurality of pages (e.g., see pluralities of pages 410a and 410b) and a plurality of application processes. Each application process of the plurality of application processes can include objects and executables loadable in the memory for execution by the processor (e.g., see groups of objects and executables 412a and 412b). The plurality of application processes can include a first group of the objects and executables and a second group of the objects and executables (e.g., see groups of objects and executables 412a and 412b). The apparatus can also include an OS.

The OS, when loaded into the memory and executed by the processor, can be configured to score the objects and executables of the plurality of application processes based on placement and movement of the objects and executables in the memory, including scoring the first group and the second group of the objects and executables of the plurality of application processes based on placement and movement of the first group and the second group of the objects and executables in the memory.

The OS, when loaded into the memory and executed by the processor, can also be configured to control loading initially, in the first type of memory, at a first plurality of pages of the plurality of pages, the first group of the objects and executables of the plurality of application processes at least according to the scoring of the first group.

And, the OS, when loaded into the memory and executed by the processor, can also be configured to control loading initially, in a second type of memory of the memory, at a second plurality of pages of the plurality of pages, the second group of the objects and executables of the plurality of application processes at least according to the scoring of the second group.

Furthermore, in some embodiments, the OS, when loaded into memory and executed by the processor, can be configured to score each object or executable of the plurality of application processes based at least partially on quantity, recency, or frequency of page faults associated with the object or the executable.

Some embodiments can include a non-transitory computer-readable storage medium tangibly encoded with computer-executable instructions (e.g., see memory 406), that when executed by a processor (e.g., see controller 404) associated with a computing device, performs a method. The method can include scoring objects and executables of a plurality of application processes of the computing device based on placement and movement of the objects and executables in a memory of the computing device, including scoring a first group and a second group of objects and executables of the plurality of application processes based on placement and movement of the first group and the second group of the objects and executables in the memory. The method can also include controlling loading initially, in a first type of memory of the memory of the computing device, at a first plurality of pages of the memory, the first group of the objects and executables of the plurality of application processes at least according to the scoring of the first group. The method can also include controlling loading initially, in a second type of memory of the memory, at a second plurality of pages of the memory, the second group of the objects and executables of the plurality of application processes at least according to the scoring of the second group.

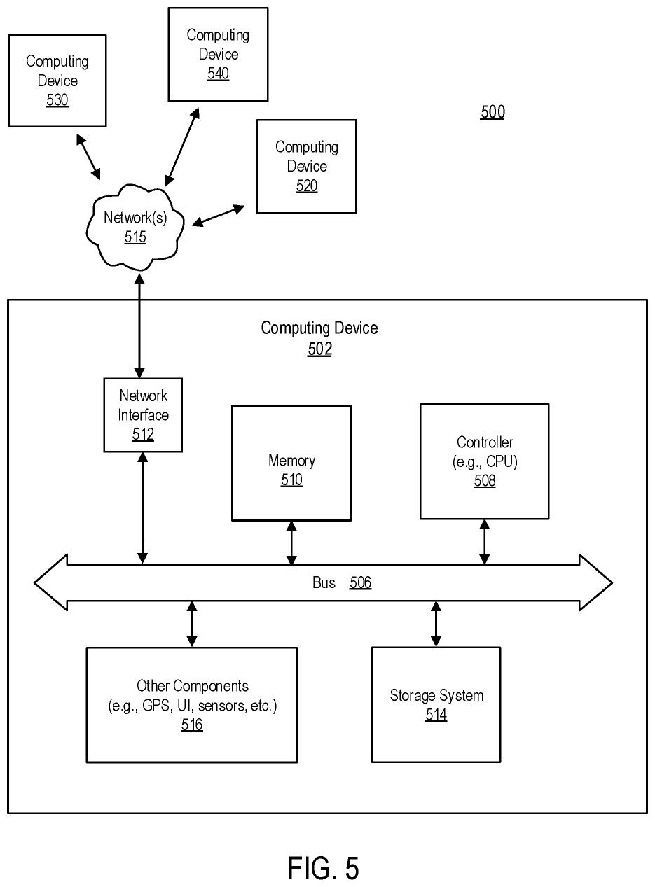

FIG. 5 illustrates an example networked system 500 that includes computing devices (e.g., see computing devices 502, 520, 530, and 540) that can provide reduction of page migration in memory while maintaining benefits of page migration for one or more devices in the networked system as well as for the networked system as a whole, in accordance with some embodiments of the present disclosure.

The networked system 500 is networked via one or more communication networks. Communication networks described herein can include at least a local to device network such as Bluetooth or the like, a wide area network (WAN), a local area network (LAN), the Intranet, a mobile wireless network such as 4G or 5G, an extranet, the Internet, and/or any combination thereof. The networked system 500 can be a part of a peer-to-peer network, a client-server network, a cloud computing environment, or the like. Also, any of the computing devices described herein can include a computer system of some sort. And, such a computer system can include a network interface to other devices in a LAN, an intranet, an extranet, and/or the Internet (e.g., see network(s) 515). The computer system can also operate in the capacity of a server or a client machine in client-server network environment, as a peer machine in a peer-to-peer (or distributed) network environment, or as a server or a client machine in a cloud computing infrastructure or environment.

Also, at least some of the illustrated components of FIG. 5 can be similar to the illustrated components of FIGS. 4A an 4B functionally and/or structurally. For example, computing devices 502, 520, 530, and 540 can each have similar features and/or functionality as the computing device 402. Other components 516 can have similar features and/or functionality as the other components 420. Controller 508 can have similar features and/or functionality as the controller 404. Bus 506 (which can be more than one bus) can have similar features and/or functionality as the buses 416 and 418a to 418c. And, network interface 512 can have similar features and/or functionality as a network interface of the computing device 402 (not depicted).

The networked system 500 includes computing devices 502, 520, 530, and 540, and each of the computing devices can include one or more buses, a controller, a memory, a network interface, a storage system, and other components. Also, each of the computing devices shown in FIG. 5 can be or include or be a part of a mobile device or the like, e.g., a smartphone, tablet computer, IoT device, smart television, smart watch, glasses or other smart household appliance, in-vehicle information system, wearable smart device, game console, PC, digital camera, or any combination thereof. As shown, the computing devices can be connected to communications network(s) 515 that includes at least a local to device network such as Bluetooth or the like, a wide area network (WAN), a local area network (LAN), an intranet, a mobile wireless network such as 4G or 5G, an extranet, the Internet, and/or any combination thereof.

Each of the computing or mobile devices described herein (such as computing devices 402, 502, 520, 530, and 540) can be or be replaced by a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine.

Also, while a single machine is illustrated for the computing device 502 shown in FIG. 5 as well as the computing device 402 shown in FIG. 4, the term “machine” shall also be taken to include any collection of machines that individually or jointly execute a set (or multiple sets) of instructions to perform any one or more of the methodologies or operations discussed herein. And, each of the illustrated computing or mobile devices can each include at least a bus and/or motherboard, one or more controllers (such as one or more CPUs), a main memory that can include temporary data storage, at least one type of network interface, a storage system that can include permanent data storage, and/or any combination thereof. In some multi-device embodiments, one device can complete some parts of the methods described herein, then send the result of completion over a network to another device such that another device can continue with other steps of the methods described herein.

FIG. 5 also illustrates example parts of the example computing device 502. The computing device 502 can be communicatively coupled to the network(s) 515 as shown. The computing device 502 includes at least a bus 506, a controller 508 (such as a CPU), memory 510, a network interface 512, a data storage system 514, and other components 516 (which can be any type of components found in mobile or computing devices such as GPS components, I/O components such various types of user interface components, and sensors as well as a camera). The other components 516 can include one or more user interfaces (e.g., GUIs, auditory user interfaces, tactile user interfaces, etc.), displays, different types of sensors, tactile, audio and/or visual input/output devices, additional application-specific memory, one or more additional controllers (e.g., GPU), or any combination thereof. The bus 506 communicatively couples the controller 508, the memory 510, the network interface 512, the data storage system 514 and the other components 516. The computing device 502 includes a computer system that includes at least controller 508, memory 510 (e.g., read-only memory (ROM), flash memory, dynamic random-access memory (DRAM) such as synchronous DRAM (SDRAM) or Rambus DRAM (RDRAM), static random-access memory (SRAM), cross-point or cross-bar memory, crossbar memory, etc.), and data storage system 514, which communicate with each other via bus 506 (which can include multiple buses).

To put it another way, FIG. 5 is a block diagram of computing device 502 that has a computer system in which embodiments of the present disclosure can operate. In some embodiments, the computer system can include a set of instructions, for causing a machine to perform any one or more of the methodologies discussed herein, when executed. In such embodiments, the machine can be connected (e.g., networked via network interface 512) to other machines in a LAN, an intranet, an extranet, and/or the Internet (e.g., network(s) 515). The machine can operate in the capacity of a server or a client machine in client-server network environment, as a peer machine in a peer-to-peer (or distributed) network environment, or as a server or a client machine in a cloud computing infrastructure or environment.

Controller 508 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, single instruction multiple data (SIMD), multiple instructions multiple data (MIMD), or a processor implementing other instruction sets, or processors implementing a combination of instruction sets. Controller 508 can also be one or more special-purpose processing devices such as an ASIC, a programmable logic such as an FPGA, a digital signal processor (DSP), network processor, or the like. Controller 508 is configured to execute instructions for performing the operations and steps discussed herein. Controller 508 can further include a network interface device such as network interface 512 to communicate over one or more communications networks (such as network(s) 515).

The data storage system 514 can include a machine-readable storage medium (also known as a computer-readable medium) on which is stored one or more sets of instructions or software embodying any one or more of the methodologies or functions described herein. The data storage system 514 can have execution capabilities such as it can at least partly execute instructions residing in the data storage system. The instructions can also reside, completely or at least partially, within the memory 510 and/or within the controller 508 during execution thereof by the computer system, the memory 510 and the controller 508 also constituting machine-readable storage media. The memory 510 can be or include main memory of the computing device 502. The memory 510 can have execution capabilities such as it can at least partly execute instructions residing in the memory.

While the memory, controller, and data storage parts are shown in the example embodiment to each be a single part, each part should be taken to include a single part or multiple parts that can store the instructions and perform their respective operations. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
scoring objects and executables of a plurality of application processes of a computing device based on placement and movement of the objects and executables in a memory of the computing device;
grouping the objects and executables based on the placement and movement of the objects and executables in the memory;
controlling loading and storing, in a first type of memory of the memory, at a first plurality of pages of the memory, a first group of the objects and executables at least according to the scoring; and
controlling loading and storing, in at least one additional type of memory of the memory, at one or more additional pluralities of pages of the memory, at least one additional group of the objects and executables at least according to the scoring.

2. The method of claim 1, wherein the scoring comprises scoring each object or executable of the plurality of application processes based at least partially on quantity, recency, or frequency of page faults associated with the object or the executable.

3. The method of claim 1, wherein the scoring comprises scoring each object or executable of the plurality of application processes based at least partially on quantity, recency, or frequency of a processor of the computing device accessing, in the memory, at least part the object or the executable.

4. The method of claim 1, wherein the scoring comprises scoring each object or executable of the plurality of application processes based at least partially on a size of the object or the executable or based at least partially on a size of parts of the object or the executable accessed by a processor.

5. The method of claim 1, wherein the scoring comprises scoring each object or executable of the plurality of application processes based at least partially on memory bus traffic.

6. The method of claim 1, wherein the scoring comprises scoring each object or executable of the plurality of application processes based at least partially on a criticality rating for the object or executable.

7. The method of claim 1, comprising:
controlling page migration of the first plurality of pages to the at least one additional type of memory, at least according to the scoring of the first group of the objects and executables; and
controlling page migration of the one or more additional pluralities of pages to the first type of memory, at least according to the scoring of the at least one additional group of the objects and executables.

8. The method of claim 7, comprising:
controlling page migration of the first plurality of pages back to the first type of memory according to the scoring of at least the first group of the objects and executables, when the first plurality of pages is located at the at least one additional type of memory; and
controlling page migration of the one or more additional pluralities of pages back to the at least one additional type of memory according to the scoring of at least the at least one additional group of the objects and executables, when the one or more additional pluralities of pages is located at the first type of memory.

9. The method of claim 8, wherein the memory comprises a second type of memory, and wherein the method comprises:
moving, via page migration, the first plurality of pages from the first type of memory to the second type of memory, initially via a first memory bus directly connected to the first type of memory and then via a second memory bus directly connected to the second type of memory, according to the scoring of at least the first group of the objects and executables; and
moving, via page migration, a second plurality of pages from the second type of memory to the first type of memory, initially via the second memory bus and then via the first memory bus, according to scoring of at least a second group of the objects and executables.

10. The method of claim 9, comprising:
moving, via page migration, the first plurality of pages from the second type of memory back to the first type of memory, initially via the second memory bus and then via the first memory bus, according to the scoring of at least the first group of the objects and executables, when the first plurality of pages is located at the second type of memory; and
moving, via page migration, the second plurality of pages from the first type of memory back to the second type of memory, initially via the first memory bus and then via the second memory bus, according to the scoring of at least the second group of the objects and executables, when the second plurality of pages is located at the first type of memory.

11. The method of claim 10, wherein the scoring is based on estimating cost of memory bus utilization to move or not to move the first and the second pluralities of pages.

12. The method of claim 1, wherein the first type of memory comprises DRAM cells.

13. The method of claim 12, wherein the second type of memory comprises at least one of a plurality of NVRAM cells, a plurality of 3D XPoint memory cells, or a combination thereof.

14. The method of claim 1, wherein the first and the at least one additional type of memory are communicatively coupled to a processor of the computing device, and wherein the first type of memory is communicatively coupled closer to the processor than the at least one additional type of memory and is faster than the at least one additional type of memory.

15. The method of claim 1, wherein at least one of the plurality of applications comprises a lightweight user interface comprising objects and executables that are relatively smaller in size than other objects and executables in the computing device, and wherein the objects and executables of the lightweight user interface are located in the first type of memory.

16. The method of claim 15, wherein the objects and executables of the lightweight user interface at least in part have corresponding objects and executables of a non-lightweight user interface, wherein the corresponding objects and executables of the non-lightweight user interface are located in the at least one additional type of memory.

17. The method of claim 16, wherein the computing device can switch between the lightweight user interface and the non-lightweight user interface at any time at least in part based on use of the computing device by a user or scoring of objects and executables.

18. An apparatus, comprising:
a processor;
a memory, comprising: a first type of memory; a second type of memory; and
a plurality of pages;
a plurality of application processes,
wherein each application process of the plurality of application processes comprises objects and executables loadable in the memory for execution by the processor, and
wherein the plurality of application processes comprises: a first group of the objects and executables; and a second group of the objects and executables; and
an operating system (OS), when loaded into the memory and executed by the processor, configured to:
score the objects and executables of the plurality of application processes based on placement and movement of the objects and executables in the memory, including scoring the first group and the second group of the objects and executables of the plurality of application processes based on placement and movement of the first group and the second group of the objects and executables in the memory;
control loading initially, in the first type of memory, at a first plurality of pages of the plurality of pages, the first group of the objects and executables of the plurality of application processes at least according to the scoring of the first group; and
control loading initially, in a second type of memory of the memory, at a second plurality of pages of the plurality of pages, the second group of the objects and executables of the plurality of application processes at least according to the scoring of the second group.

19. The apparatus of claim 18, wherein the OS, when loaded into memory and executed by the processor, is configured to score each object or executable of the plurality of application processes based at least partially on quantity, recency, or frequency of page faults associated with the object or the executable.

20. A non-transitory computer-readable storage medium tangibly encoded with computer-executable instructions, that when executed by a processor associated with a computing device, performs a method, the method comprising:
scoring objects and executables of a plurality of application processes of the computing device based on placement and movement of the objects and executables in a memory of the computing device, including scoring a first group and a second group of objects and executables of the plurality of application processes based on placement and movement of the first group and the second group of the objects and executables in the memory;
controlling loading initially, in a first type of memory of the memory of the computing device, at a first plurality of pages of the memory, the first group of the objects and executables of the plurality of application processes at least according to the scoring of the first group; and
controlling loading initially, in a second type of memory of the memory, at a second plurality of pages of the memory, the second group of the objects and executables of the plurality of application processes at least according to the scoring of the second group.
